(19) United States
(12) Patent Application Publication
(10) Pub. No.: US 2009/0080978 A1
(43) Pub. Date: Mar. 26, 2009

(54) Movable agricultural reservoir cover with hatch, and a method for liquefying a content of an agricultural reservoir

(75) Inventors: Darin Evans, Fredericton (CA); Brennan M. Sisk, Fredericton (CA)

Correspondence Address: MARIO D. THERIAULT, 812 HWY. 101 NASONWORTH, FREDERICTON, NB, E3C 2B5, CA

(73) Assignee: Geomembrane Technologies Inc.

(21) Appl. No.: 12/230,558

(22) Filed: Sep. 2, 2008

Related U.S. Application Data
(60) Provisional application No. 60/960,195, filed on Sep. 20, 2007.

(51) Int. Cl. A01C 3/02

(52) U.S. Cl. 405/63; 405/53; 52/3; 366/348

(57) ABSTRACT

A reservoir is covered by an impermeable flexible floating membrane cover through which is mounted a hatchway. The cover is movable as a raft over the content of the reservoir for positioning the hatchway at one location or another. In use, a pumping and agitating device is introduced inside the reservoir through the hatchway and operated at one location, and then at another location for pumping, mixing and liquify the entire content of the reservoir without aerating the content of the reservoir. The fertilizing properties of livestock manure in storage inside the reservoir are thereby preserved.

This application claims the benefit of U.S. Provisional Application No. 60/960,195, filed Sep. 20, 2007.

### FIELD OF THE INVENTION

This invention pertains to covered agricultural reservoirs and more particularly it pertains to a manure reservoir including a floating cover having a hatch near its outside rim and a clearance between the outside rim and the inside wall surface of the reservoir such that the cover is movable at the surface of the reservoir to position the hatch anywhere around the reservoir. The present invention also pertains to a method for mixing and agitating of the content of a manure reservoir.

### BACKGROUND OF THE INVENTION

Livestock manure is an excellent biological fertilizer that has been used since the beginning of agriculture. Livestock manure has high value in maintaining and fertilizing a soil because of the plant nutrients, humus, and organic and fibrous substances contained in it. It is known that a high percentage of the nitrogen, phosphorus, and potassium fed to dairy cows for example, are excreted in manure. These elements are basic nutrients that plants need for growth.

The fertilizing properties of cattle, poultry and swine manure, however, are depending upon several factors. It has been found for example, that the fertilizing properties of manure depend on the conditions in which the manure is stored prior to spreading it on crop fields.

When the manure is exposed to air, a chemical process takes place and causes nitrogen to be released into the atmosphere under different forms. Before the manure can be spread on a field, the proper balance in the fertilizing elements must be restored by adding chemical nitrogen into the manure. This additional operation is costly. Therefore there is a first incentive for farmers to carefully store the manure in a reservoir that is airtight to some extent, to minimize a loss of nutrients.

In another aspect, the accumulation of rainwater and melting snow inside an uncovered manure reservoir reduces the capacity of the reservoir and increases the handling and transport costs for spreading this diluted manure on a field. Therefore this is a second incentive for farmers to store the manure under an impermeable cover to prevent dilution with water.

Another requirement to preserve the fertilizing properties of cattle or swine manure during storage consists of periodically agitating the content of the reservoir with a portable pumping and agitating device to promote fermentation. In common practice with open reservoirs, however, this agitation is rarely effected because the odor that is generated from the reservoir during this operation draws criticisms by neighbors.

The covering of agricultural reservoirs has been addressed in the past, and several examples of covered reservoirs are disclosed in the documents identified below.

A first type of covered reservoir for storing livestock manure is described in;
GB Patent Application 2,072,649, published by L. Mellen on Oct. 7, 1981. This document describes a reservoir having an access well extending vertically alongside of the reservoir. The well contains pipes and a nozzle by which a circulation can be created inside the reservoir to agitate the content of the reservoir.

Another type of covered manure reservoir is described in;
U.S. patent application Ser. No. 11/099,790; (Publication no. US/2005/0252093), filed by Claude J. Degarie on Apr. 6, 2005. This cover has a flexible floating cover thereon and a hatchway through the cover, through which agitation of the content of the reservoir can be done.

The well and hatch in the manure reservoirs identified above are advantageous for allowing the agitation and mixing of the content of these reservoirs for preventing sedimentation and stratification of the content of the reservoirs. However, this well and hatch are at a fixed location adjacent to the wall of the reservoir, and agitation of the content of the reservoir can only be effected from one location around the reservoir. When a reservoir has a diameter that is much larger than the reach of the mixing and pumping device available to do the mixing, buildups still occur in regions of the reservoir far from the well or from the hatch.

The prior art also contains other floating covers with hatches. Although these additional floating structures are not appropriate for manure reservoirs, several examples are provided herein below to illustrate the prior art preceding the present invention.

In addition to the above-mentioned patent application by C. J. Degarie, examples of floating covers with hatches are as follows:
U.S. Pat. No. 239,431 issued to W. H. Birge on Mar. 29, 1881;
U.S. Pat. No. 2,625,314 issued to F. D. Moyer on Jan. 13, 1953;
U.S. Pat. No. 3,036,342 issued to A. F. Fino on May 29, 1962;
U.S. Pat. No. 3,120,902 issued to A. M. Southworth et al., on Feb. 11, 1964;
CA Patent 263,125 issued to A. J. Holt on Aug. 3, 1926;
CA Patent 362,068 issued to W. G. McCullam on Nov. 24, 1936;
CA Patent 897,613 issued to W. E. Belanger on Apr. 11, 1972;

Also, other floating covers incorporating flexible membranes are numerous in the prior art. Examples of these floating covers are:
U.S. Pat. No. 2,870,455 issued to C. F. G. Reeves on Jan. 27, 1959;
U.S. Pat. No. 3,600,721 issued to E. H. Pusey on Aug. 24, 1971;
U.S. Pat. No. 3,940,809 issued to G. A. Hughes on Mar. 2, 1976;
U.S. Pat. No. 4,135,257 issued to Lance G. A. Löf on Jan. 23, 1979;
U.S. Pat. No. 4,251,889 issued to Lance Löf on Feb. 24, 1981;
CA Patent 653,559 issued to A. E. Scheible on Dec. 4, 1962;
CA Patent 725,452 issued to N. M. Anderson on Jan. 11, 1966;
CA Patent 802,683 issued to A. J. Wiltshire on Dec. 31, 1968;

Although the prior art discloses membrane-type floating covers and floating covers with hatches, the prior art is silent with regard to a floating cover having a hatch that can be moved at any location around a reservoir, such that the entire content of the reservoir can be agitate and liquefied.

For these reasons, it is believe that a need exists for a floating membrane cover that has a hatch therein and wherein the hatch can be moved to any location along the circumference of the reservoir.

### SUMMARY OF THE INVENTION

In the present invention, however, there is provided a reservoir that is covered by an impermeable flexible floating membrane cover and through which is mounted a hatchway. The cover is movable as a raft over the content of the reservoir for positioning the hatchway at one location or another. In use, a pumping and agitating device is introduced inside the reservoir through the hatch and operated at one location, and then at another location for pumping, mixing and liquify the entire content of the reservoir without aerating the reservoir.

More specifically, in one aspect of the invention, there is provided a reservoir having a circular cover mounted therein. The cover floats over the fluid content of the reservoir. The floating cover has a hatch therein. There is also provided a clearance between an inside wall surface of the reservoir and a circumference of the cover for allowing a free rotation of the cover inside the reservoir, for positioning the hatch at different locations around the reservoir. A pumping and agitating device can be introduced through the hatch at each of these different locations to agitate and circulate the entire content of the reservoir.

In another aspect of the present invention, there is provided a manure reservoir having a fluid content and a circular cover floating over this fluid content. The reservoir has two or more access ways thereabout providing access to the reservoir by a vehicle carrying a pumping and agitating device. The cover has a hatch therein and this hatch has dimensions for receiving the pumping and agitating device there through. The cover also has means including a free-wheeling clearance around it for allowing a rotation of the cover and the hatch relative to the reservoir from a first position wherein the hatch is adjacent one of the access ways to a second position where the hatch is adjacent another one of the access ways.

In yet another aspect of the present invention, the cover is made of a flexible impermeable membrane floating over the content of the reservoir. This floating cover reduces the air space at the surface of the reservoir, and has the ability to rise with the accumulation of material inside the reservoir. This floating cover prevents degradation of the fertilizing elements found in livestock manure. This floating cover also prevents dilution of manure with rain water and melting snow.

In yet a further aspect of the present invention, there is provided a method for agitating and liquefying a content of a manure reservoir while preventing aeration of the content of the reservoir. This method includes the steps of:
covering the content of the reservoir with a flexible floating cover having a hatch therein;
positioning the hatch at a first location;
introducing a pumping and agitating device through the hatch and agitating and circulating the content of the reservoir at the first location;
moving the hatch to a second location in the reservoir, different from the first location and agitating and circulating the content of the reservoir at the second location;
repeating the steps of moving the hatch and agitating and circulating the content of the reservoir, at subsequent locations different from each other and from the first and second locations, until the entire content of the reservoir has been agitated and circulated.

This method is advantageous for preserving the fertilizing properties of livestock manure in storage inside a reservoir.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

A preferred embodiment of the present invention is illustrated in the accompanying drawings, in which like numerals denote like parts throughout the several views, and in which:

FIG. 1 is a plan view of a manure reservoir with a movable floating cover according to the preferred embodiment of the present invention mounted inside this reservoir;

FIG. 2 is a cross section view of the side of the reservoir as seen along line 2-2 in FIG. 1;

FIG. 3 is a cross section view of the side of the reservoir as seen along line 3-3 in FIG. 1;

FIG. 4 is a plan view of the movable cover floating over the reservoir;

FIG. 5 is a plan view of the movable floating cover during its fabrication;

FIG. 6 is a cross-section view of the floating cover over another manure reservoir, wherein the mixing pipes are mounted outside the reservoir;

FIG. 7 is a cross-section view of the floating cover mounted over an earthen reservoir.

### DESCRIPTION OF THE PREFERRED EMBODIMENT

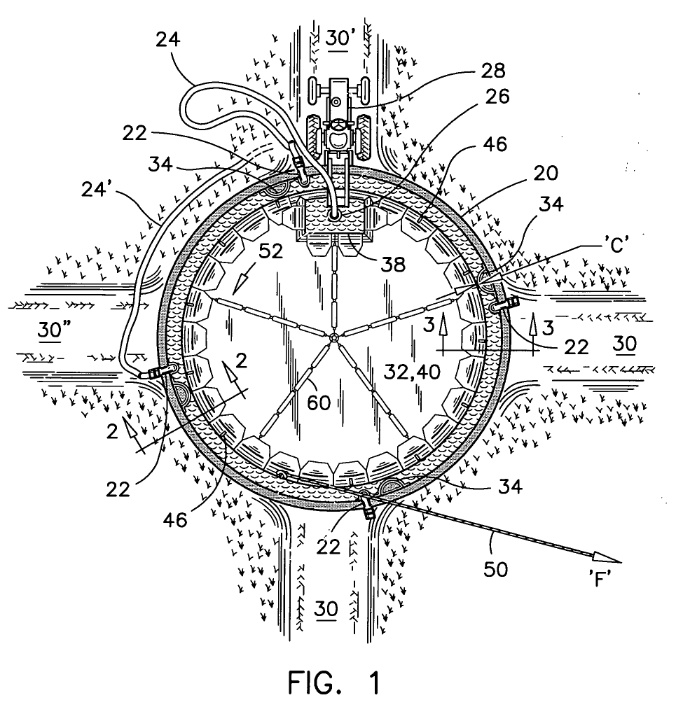

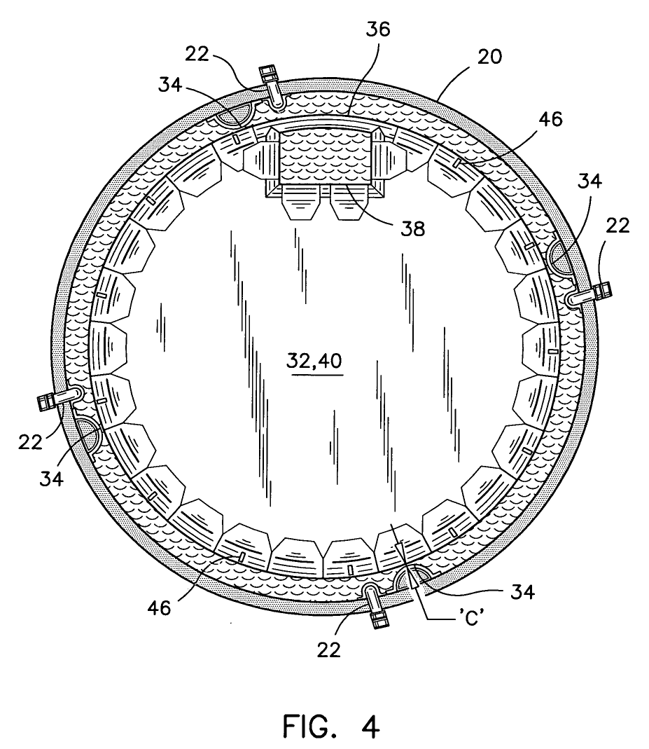

Referring firstly to FIGS. 1-3 and 4, a first covered manure reservoir 20 is illustrated therein. The manure reservoir 20 has a circular shape and several mixing pipes 22 that are affixed to the inside wall of the reservoir 20 at different locations around the reservoir. Any one of these mixing pipes 22 can be connected by a hose 24 for example to a pumping and agitating device 26 that is periodically submerged inside the reservoir 20. The pumping and agitating device 26 is generally driven by the power-take-off shaft of a farm tractor 28.

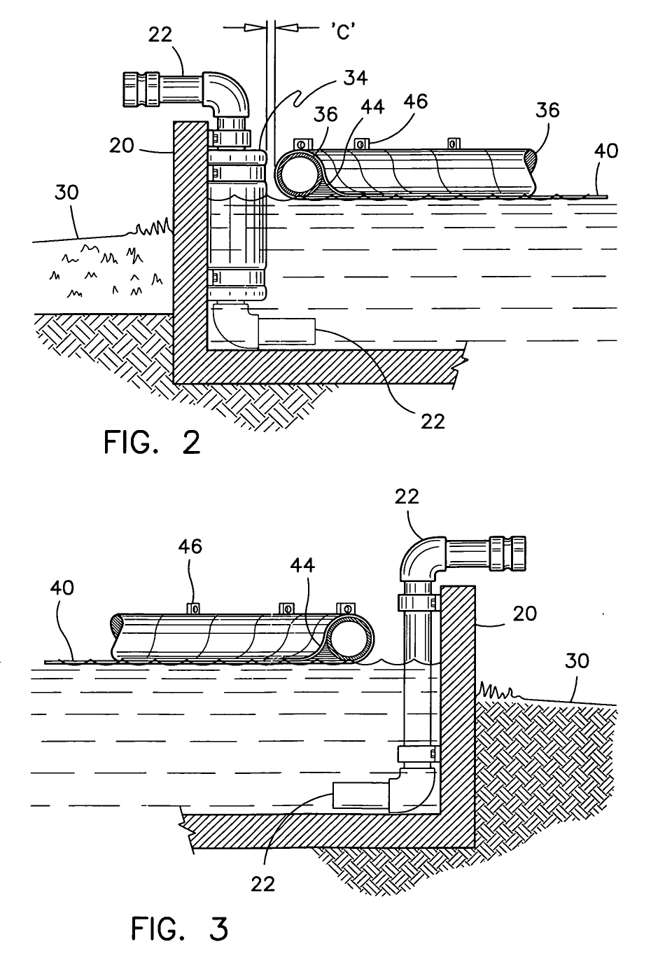

The pumping and agitating device 26 has an auger-type impeller (not shown) to break any clumps of material inside the reservoir, to process the content of the reservoir into a slurry and to pump the slurry through the hose 24 and back into the reservoir through one of the mixing pipes 22. The slurry is discharged along the bottom surface of the reservoir as may be understood from the illustration in FIG. 2.

While the pumping and agitating device 26 is installed at one location, the hose 24 can be connected to a mixing pipe 22 at some distance from the pumping and agitating device 26, as illustrated by label 24′ in FIG. 1. A single pumping and agitating device 26 can also be connected to more than one mixing pipes 22 if one wants to, using hoses and hose fittings that are well known to those in this field.

While the mixing pipes 22 are shown as rigid pipes solidly affixed to the side wall of the reservoir, it will be appreciated that these mixing pipes can also be a simple hose for example that is movable in and out of the reservoir by hand.

The preferred reservoir 20 has at least two or more access ramps, access paths, or similar driveways, leading to its side wall, so that a farm tractor 28 can reach close enough to the side wall of the reservoir to operate a pumping and agitating device 26 installed inside the reservoir at that location. These access ramps, access paths, or similar driveways are referred to generally herein as access ways 30.

As shown in FIGS. 1 and 2, the outside diameter of the floating movable cover 32 is smaller than the inside diameter of the reservoir. If mixing pipes 22 are present inside the reservoir and are affixed to the inside wall of the reservoir, such as illustrated in FIG. 2, a series of bumpers 34 are provided on the inside wall of the reservoir. These bumpers 34 are preferably provided near every mixing pipe 22. Each bumper 34 has a semi-cylindrical shape and a thickness from the inside wall of the reservoir that is larger than the thickness of a mixing pipe 22. Each bumper 34 may also be installed to respectively enclose one of the mixing pipes 22. The outside diameter of the cover is smaller than the distance between opposite bumpers 34 such as to maintain a radial clearance ‘C’ between the cover and each bumper 34.

The radial clearance ‘C’ should be about a four to six inches for reservoirs that have a diameter of twenty feet or more. If no mixing pipe is present inside the reservoir, a same radial clearance ‘C’ should be maintained between the cover and the inside wall of the reservoir.

The purpose of the clearance ‘C’ is to allow the cover to be rotated freely inside the reservoir 20 without rubbing excessively against the side wall of the reservoir, against one of the mixing pipes 22 or against one of the bumpers 34. Therefore, although a dimension for the radial clearance ‘C’ is given above, it should be understood that this clearance may have another dimension than the one specified above. The criteria to determine an appropriate clearance is that the clearance must be sufficiently large to allow the cover to be rotated freely, even when there is an out of roundness in the cover itself or in the wall of the reservoir. This clearance is referred to as a free-wheeling clearance.

The loss of fermentation gases along the gap ‘C’ in many applications may be considered negligible as compared to the surface of the reservoir enclosed under the cover 32. It is known that in some manure reservoirs, there is scum accumulating at the surface of the reservoir. This scum tends to form a cake when exposed to air. This scum is advantageous for at least partly sealing the gap ‘C’ and also for acting as an absorber for preventing, to some extent, the drifting of the cover toward the wall of the reservoir during its rotation.

Also, an annular-shaped skirt (not shown) may be affixed to the inside wall of the reservoir or to the circumference of the floating cover for the purpose of sealing the space around the floating cover 32.

The movable floating cover 32 also has a rim pipe 36 which constitutes a structural frame thereof. The movable floating cover 32 also has a hatch 38 adjacent to but inside the rim pipe 36. The rim pipe 36 is preferably made of a plastic material and has a cross section diameter of eight inches or more. The preferred plastic material contains thermoplastic material so that the pipe can be fabricated and welded on an installation site using hot-melt welding equipment.

In use, the hatch 38 is positioned adjacent one of the access ways 30, for allowing the mixing the content of the reservoir 20 at that location. Then, the cover is rotated for positioning the hatch 38 adjacent another access way 30 for allowing the mixing of the content of the reservoir at that other location. The entire reservoir can thereby be agitated from different locations around the reservoir, to maintain a better consistency of the entire content of the reservoir.

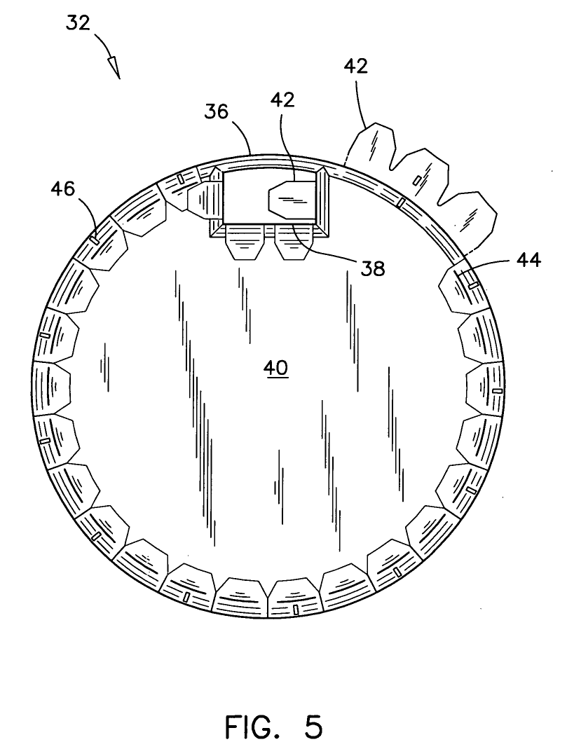

Referring now to FIG. 5, the floating movable cover is illustrated during its fabrication. The hatch 38 is preferably enclosed inside the rim pipe 36 such that there is no interruption in the rim pipe, and such that the integrity of the structure of the cover is not affected by the presence of the hatch 38.

When the hatch 38 is not used, it is preferably closed by a blanket-type gas-impermeable closure (not shown).

The rim pipe 36 forms a ring around a gas impermeable membrane sheet 40. The membrane sheet 40 lays directly over the content of the reservoir to prevents bio-gases from escaping from the content of the reservoir. The membrane also prevents rainwater from mixing with the content of the reservoir. Moreover, the membrane sheet 40 prevents air from coming in contact with the content of the reservoir.

The membrane sheet 40 is preferably made of a gas-impermeable stretch-resistant polyethylene-based pliable sheet material. The material is selected to provide sufficient strength to allow workers to walk on the cover, for the purpose of installing portable sump pumps to remove rainwater from the cover, or to remove accumulated snow by shoveling or blowing it if required, or for doing regular inspection and preventive maintenance of the cover.

The preferred membrane sheet 40 has a smooth bottom surface that is in contact with the content of the reservoir, such that the friction of the cover over the content of the reservoir is as small as possible.

During fabrication of the cover 32, the rim pipe 36 is welded together on the installation site to form a closed loop. The rim pipe 36 is then laid on the membrane sheet 40. The preferred membrane sheet 40 is larger than the circle formed by the rim pipe 36. The membrane sheet 40 is trimmed around its perimeter to form several flaps 42. These flaps 42 are folded over the rim pipe 36 and are bonded to the top surface of the membrane sheet 40 by hot-melt welds, as to form a hem 44 around the cover 32, enclosing the rim pipe 36, as illustrated in FIGS. 2 and 3.

The rim pipe 36 preferably has lugs 46 at intervals on its upper surface. These lugs 46 are used for lifting the cover 32 over the reservoir 20 and for installing the cover over the reservoir using a crane for example. More importantly, these lugs 46 are used for applying torque on the rim pipe 36, for rotating the cover 32 inside the reservoir 20.

In use, one or more ropes 50, as shown in FIG. 1, are attached to one or more lugs 46 and are used to apply forces ‘F’ that are tangent to the rim pipe 36, to rotate the cover 32. These forces ‘F’ are applied to move the hatch 38 in a direction as shown by arrow 52 for example, from a first access way 30′ to a second access way 30″ for example. The pumping and agitating device 26 and farm tractor 28 can then be relocated at the second access way 30″ to mix, pump and circulate the content of the reservoir near that second access way 30″.

The same process is repeated to agitate, pump and circulate the content of the reservoir at all access ways 30 around the reservoir. It will be appreciated, that the mobility of the hatch and the number of access ways 30 around the reservoir 20 also facilitate the recovery of manure from the reservoir for loading manure spreaders.

Referring back to FIG. 1, a series of weight lines 60 may be installed over the cover to prevent wind-induced stress in the membrane 40 of the cover. A second reason for installing weight lines 60 is to cause rain water to accumulate along these weight lines, where it is more easily removed.

It will also be appreciated that the floating cover 32 may also be installed in a reservoir 70 wherein the mixing pipes 22 are mounted outside the wall of the reservoir as illustrated in FIG. 6. In that installation, a free-wheeling clearance ‘C’ is maintained between the cover 32 and the inside wall surface of the reservoir.

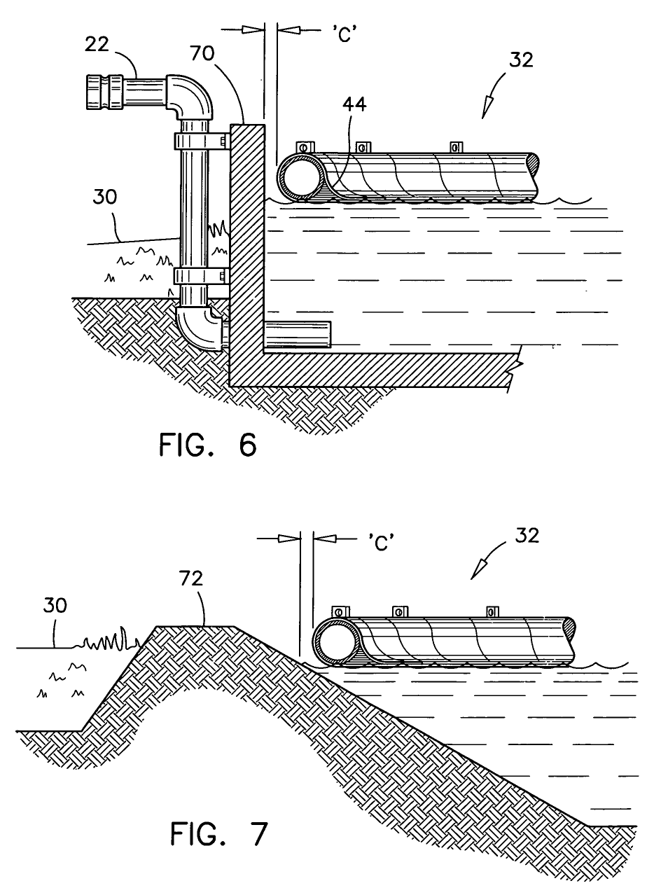

Again, it will be appreciated that the floating cover 32 may be installed over an earthen reservoir 72, as illustrated in FIG. 7, and the free-wheeling clearance ‘C’ in that case is maintained in a similar manner as previously described to allow the floating cover 32 to be rotated by manual force.

Although a circular reservoir has been illustrated herein, it will be appreciated that the movable cover can also be installed over a rectangular or square reservoir. In that type of installation, the corners of the reservoir are preferably covered with spandrel-like sections that are immovably affixed to the reservoir. A circular cover 32 with a hatch 38 as described herein is mounted at the center of the reservoir and a clearance ‘C’ is maintained between the rim of the cover and the spandrel-like sections to allow for the rotation of circular cover.

What is claimed is:

1. A reservoir having a fluid content and a circular cover mounted therein, floating over said fluid content; said circular cover having a hatch therein and said reservoir including a free-wheeling clearance between an inside wall surface of said reservoir and a circumference of said circular cover for allowing a rotation of said cover and said hatch inside said reservoir.

2. The reservoir as claimed in claim 1, further including bumpers mounted to said inside wall of said reservoir, and said free-wheeling clearance is between a surface of each of said bumpers and a circumference of said circular cover.

3. The reservoir as claimed in claim 1, further having weight lines laid over said circular cover.

4. The reservoir as claimed in claim 1, further having a plurality of mixing pipes affixed at spaced intervals to said inside wall of said reservoir.

5. A manure reservoir having a fluid content and a circular cover floating over said fluid content; said reservoir having two or more access ways thereabout providing access to said reservoir by a vehicle carrying a pumping and agitating device;
said cover having a hatch therein and said hatch having dimensions for receiving said pumping and agitating device there through; and
said cover having means including a free-wheeling clearance thereabout, for allowing a rotation of said cover and said hatch relative to said reservoir from a first position wherein said hatch is adjacent one of said access ways to a second position where said hatch is adjacent to another one of said access ways.

6. The manure reservoir as claimed in claim 5, further including bumpers mounted to said inside wall of said reservoir, and said free-wheeling clearance is between a surface of each of said bumpers and a circumference of said circular cover.

7. The manure reservoir as claimed in claim 5, wherein said circular cover has a rim pipe defining a circle, and a membrane affixed to said rim pipe and covering said circle.

8. The manure reservoir as claimed in claim 7, wherein said hatch is an opening in said membrane, inside said rim pipe.

9. The manure reservoir as claimed in claim 8, wherein said rim pipe has lugs protruding therefrom and each of said lug has a hole there through for retaining a rope.

10. The manure reservoir as claimed in claim 8, wherein said circular cover has weight lines laid thereon.

11. The manure reservoir as claimed in claim 6, further having a plurality of mixing pipes affixed at spaced intervals to said inside wall of said reservoir.

12. The manure reservoir as claimed in claim 11, further having one of said access ways adjacent each one of said mixing pipes.

13. The manure reservoir as claimed in claim 11, further having one of said bumpers near one of said mixing pipes.

14. The manure reservoir as claimed in claim 5, wherein said reservoir is an earthen reservoir.

15. The manure reservoir as claimed in claim 7, where said membrane has a smooth surface.

16. The manure reservoir as claimed in claim 7, wherein said membrane has a hem there around enclosing said rim pipe.

17. A method for agitating and liquefying a content of a manure reservoir while preventing aeration of said content; including the steps of:
covering said reservoir with a floating cover having a hatch in said floating cover;
positioning said hatch at a first location;
introducing a pumping and agitating device through said hatch and agitating and circulating said content at said first location;
moving said hatch at a second location in said reservoir, different from said first location and agitating and circulating said content at said second location;
repeating said steps of moving said hatch and agitating and circulating said content, at subsequent locations different from each other and from said first and second locations, until a substantial portion of said content of said reservoir has been agitated and circulated.

18. The method for agitating and liquefying as claimed in claim 17, further including the step of drawing a sample of said content from said first location and pumping said sample back into said reservoir at said second location.

19. The method for agitating and liquefying as claimed in claim 18, further including the step of simultaneously pumping said sample back into said reservoir at said second location and at one of said subsequent locations.

20. The method for agitating and liquefying as claimed in claim 17, wherein said sample is pumped back into said reservoir near a bottom surface of said reservoir.
